(19) United States
(12) Patent Application Publication
(10) Pub. No.: US 2007/0013966 A1
(43) Pub. Date: Jan. 18, 2007

(54) Device and method for detecting position of carrier in scanner

(75) Inventor: Yeo-phil Yoon, Hwaseong-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/480,548

(22) Filed: Jul. 5, 2006

(30) Foreign Application Priority Data
Jul. 4, 2005 (KR) 2005-59666

(51) Int. Cl. G06F 3/12; H04N 1/36

(52) U.S. Cl. 358/412; 318/603; 358/1.1

(57) ABSTRACT

A device and method for detecting a position of a carrier in a scanner includes a scanner having a carrier on which a sensor that senses an image is installed, a motor that moves the carrier, and a motor driving unit that drives the motor, and having a device which detects the position of the carrier, having an impeller that is installed on a driving axis of the motor and rotates as the motor is driven, a driving axis sensor that outputs a detection signal according to the rotation of the impeller, and a control unit that detects the position of the carrier based on the detection signal.

### CROSS-REFERENCE TO RELATED APPLICATIONS

This application claims the benefit of Korean Application No. 2005-59666, filed Jul. 4, 2005, in the Korean Intellectual Property Office, the disclosure of which is incorporated herein by reference.

### BACKGROUND OF THE INVENTION

1. Field of the Invention

Aspects of the present invention relate to the detection of a position of a carrier in a scanner, and in particular, to a device and method for easily determining whether a scanner is locked by detecting the number of rotations of an impeller installed on a motor axis, and accurately detecting a position of a carrier in a scanner even when a home position for detecting the position of the carrier cannot be detected.

2. Description of the Related Art

FIG. 1 is a perspective view schematically illustrating a scanner according to the related art. Referring to FIG. 1, the scanner includes a glass plate 11 on which a picture 10 is placed, a carrier 12 including a charge coupled device (CCD) or a contact image sensor (CIS) that scans an image, a scan motor 13 which produces a driving force to move the carrier 12, a gear train 14 which increases or reduces the driving force of the scan motor 13, a belt 15 which moves the carrier 12 by using the driving force of the scan motor 13, a pulley 16 which transmits the driving force from the scan motor 13 to the belt 15, a belt tension unit 17 which controls tension of the belt 15, a guide shaft 18 which guides the movement of the carrier 12 such that the carrier 12 moves smoothly, a printed circuit board assembly (PCBA) 19 which controls scan data and driving operations of the scanner, and a cable 20 which outputs the scan data after a scanning operation is completed.

The operation of the scanner as described above and as illustrated in FIG. 1 is as follows. First, the computer and the scanner are simultaneously driven to scan the image of the picture 10. A scanner cover (not shown) is opened, the picture 10 is placed in a scanning area on the glass plate 11, and then the scanner cover is closed. Next, a scanning program is executed in the computer causing the PCBA 19 to drive the scan motor 13. A driving force of the scan motor 13 is transmitted to the pulley 16 through the gear train 14. The gear train consequently drives the belt 15. Subsequently, the carrier 12 connected to the belt 15 moves along the guide shaft 18 due to the driving force of the belt 15 and starts a scanning operation. During this operation, the belt 15 is constantly maintained at a predetermined level of tension by the belt tension unit 17. When the carrier 12 moves and completes the scanning operation, scan data is outputted via the cable 20. Meanwhile, an image that is outputted in such a manner is displayed on a monitor of the computer, and the overall scanning operation is completed in such a way that a user can edit or modify the outputted image using an editing program and then can store the edited or modified image in a desired image file format.

To scan an image, a scanner having the above structure must first detect the position of a carrier. If the position of the carrier is not detected, exact position information of the image to be recognized cannot be obtained. Therefore, the carrier includes a unit capable of recognizing a home position, in other words, a home position detecting sensor.

FIG. 2 is a plan view schematically illustrating the scanner of FIG. 1 according to the related art. Referring to FIG. 2, the scanner initially checks whether the carrier 12 is at a home position 22 before scanning an image. If the carrier 12 is not at the home position 22, the scanner moves the carrier 12 in the direction indicated by the arrow B in FIG. 2, to the home position 22. Through an interaction between a plurality of home position detecting sensors 24 installed on the carrier 12 and a member (not shown) indicating the home position 22, the scanner can check whether the carrier 12 is located at the home position 22. When the carrier 12 is verified to be at the home position 22, the carrier 12 moves in a direction indicated by the arrow A in FIG. 2 to scan the image of a document. In this case, the carrier 12 moves along a section according to a predetermined time or distance value, or by sensing a predetermined mark. Then, the carrier 12 moves back to the home position 22 in the direction indicated by the arrow B in FIG. 2 when the scanner confirms that the carrier 12 completely moves to a predetermined position on the section. When the carrier 12 returns to the home position 22, the image recognizing operation is completed.

However, the scanner according to the related art depends on the home position detecting sensors 24 in order to detect the position of the carrier 12. The scanner confirms how far the home position detecting sensors 24 of the carrier 12 are apart from the home position 22 by counting pulses of the scan motor 13. If power is turned off and turned on again during scanning, the carrier 12 must be honed to the home position 22 since the position of the carrier 12 cannot be identified. When the carrier 12 is honed to the home position 22, the home position detecting sensors 24 cannot detect the home position 22, and the carrier 12 can crash against an end wall of the scanner and be damaged, or stress can be produced in the motor.

To prevent damage to the scanner due to over-movement of the carrier 12, the scanner can be locked in order not to move the carrier 12. When a user does not notice the scanner lock and operates the scanner, noise is generated and excessive stress is produced in the motor, which can reduce the life of the motor.

### SUMMARY OF THE INVENTION

Aspects of the present invention provide a device and method for easily determining whether a scanner is locked by detecting the number of rotations of an impeller installed on a motor axis and accurately detecting a position of a carrier by detecting the number of rotations of the impeller even when a home position is not detected.

According to an aspect of the present invention, there is provided a device which detects a position of a carrier in a scanner, the scanner including a carrier on which a sensor that senses an image is installed, a motor that moves the carrier, and a motor driving unit that drives the motor, and the device including an impeller that is installed on a driving axis of the motor and rotates as the motor is driven; a driving axis sensor that outputs a detection signal according to the rotation of the impeller; and a control unit that detects the position of the carrier based on the detection signal.

The driving axis sensor may comprise a light emitting portion and a light receiving portion, and outputs the detection signal according to whether light emitted from the light emitting portion is not blocked by the impeller and reaches the light receiving portion.

When the scanner is powered on, the control unit may output a predetermined number of pulses to the motor driving unit, and check whether the scanner is locked based on the detection signal from the driving axis sensor. The predetermined number of pulses may be 4 or more.

The control unit may include a pulse number detecting portion that detects the number of pulses output to the motor driving unit to drive the motor; an error calculating portion that compares the number of pulses detected by the pulse number detecting portion with the number of rotations of the impeller which is characterized by the detection signal from the driving axis sensor and calculates an error, and an error correcting portion that corrects the error and detects the position of the carrier.

According to another aspect of the present invention, there is provided a method of detecting a position of a carrier in a scanner, the scanner including the carrier on which a sensor that senses an image is installed, a motor that moves the carrier, and a motor driving unit that drives the motor, and the method including checking whether the scanner is locked by outputting a predetermined number of pulses to the motor driving unit when the scanner is powered on, initializing the scanner if the scanner is not locked, and detecting the position of the carrier by detecting the number of rotations of an impeller installed on a driving axis of the motor when the carrier is moved in response to an input scanning command.

The detection of the position of the carrier may include detecting the number of pulses for driving the motor driving unit and detecting the number of rotations of the impeller installed on the driving axis of the motor when the carrier is moved in response to the input scanning command, calculating an error by comparing the number of pulses and the number of rotations of the impeller, and detecting the position of the carrier by correcting the error.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view schematically illustrating a scanner according to the prior art;

FIG. 2 is a plan view schematically illustrating the scanner of FIG. 1 according to the related art;

FIG. 3 is a cross-sectional view of a scanner that includes a carrier position detecting device according to an embodiment of the present invention;

FIG. 4 illustrates in detail an impeller and a driving axis sensor of FIG. 3 according to an embodiment of the present invention;

FIG. 5 is a block diagram of a carrier position detecting device of a scanner according to an embodiment of the present invention; and

FIGS. 6A and 6B are flowcharts illustrating a method of detecting a position of a carrier according to an embodiment of the present invention.

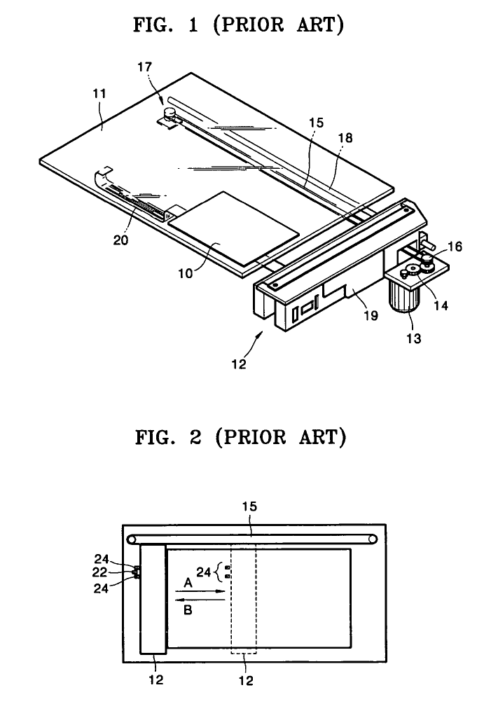

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

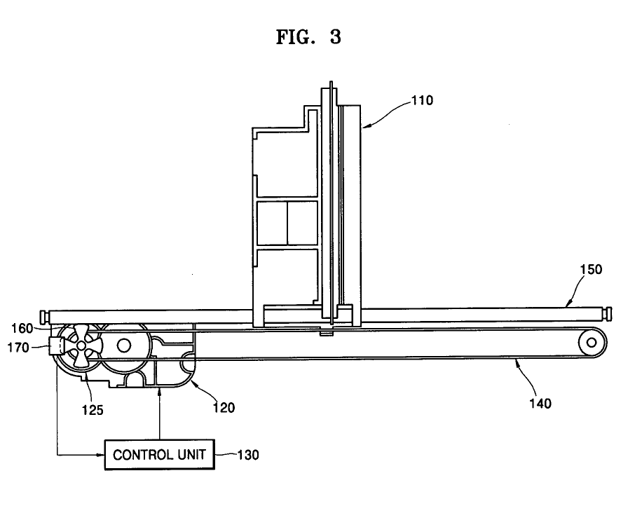

FIG. 3 is a cross-sectional view of a scanner that includes a carrier position detecting device according to an embodiment of the present invention.

Referring to FIG. 3, the scanner includes a carrier 110, a motor driving unit 120, a motor 125, a control unit 130, a timing belt 140, a guide shaft 150, an impeller 160, and a driving axis sensor 170.

A scanning unit (not shown) which includes a sensor is mounted on the carrier 110. The sensor may be a charge coupled device (CCD) sensor. The carrier 110 is moved by a rotation driving force of the motor 125, and the motor 125 is driven by the motor driving unit 120. The carrier 110 is supported by a base (not shown) on which a home position of the carrier 110 is established.

The carrier 110 includes a home position detecting sensor (not shown) that detects the home position.

The motor 125 transmits the rotation driving force to the timing belt 140 and rotates clockwise and counter clockwise, causing the timing belt 140 to correspondingly move the carrier 110 linearly forwards and backwards. The guide shaft 150 guides the movement of the carrier 110 so that the carrier 110 can move smoothly.

The control unit 130 outputs motor driving pulses to the motor driving unit 120 for driving the motor 125. Also, the control unit 130 detects the position of the carrier 110 in response to a detection signal sent from the driving axis sensor 170.

The control unit 130 outputs a predetermined number of pulses to the motor driving unit 120 and checks whether the scanner is locked in response to the detection signal from the driving axis sensor 170 when the scanner is powered on. In this case, the number of pulses outputted to the motor driving unit 120 may preferably be four or more. However, the number of pulses is not limited to being four or more. The control unit 130 determines that the scanner is locked when a signal detected by the driving axis sensor 170 is at a continuously low level or a continuously high level because the impeller 160 does not rotate even though the motor 125 is driven by the pulses outputted to the motor driving unit 120. In this way, the control unit 130 can promptly determine whether the scanner is locked or not, and thus, stress on the motor can be reduced.

The impeller 160 is installed on the driving axis of the motor 125, and rotates clockwise or counter clockwise according to the driving direction of the motor 125. The impeller 160 cools the motor 125 and prevents the motor 125 from overheating.

The driving axis sensor 170 detects the number of rotations of the impeller 160, and outputs a detection signal to the control unit 130 after detecting the number of rotations of the impeller 160.

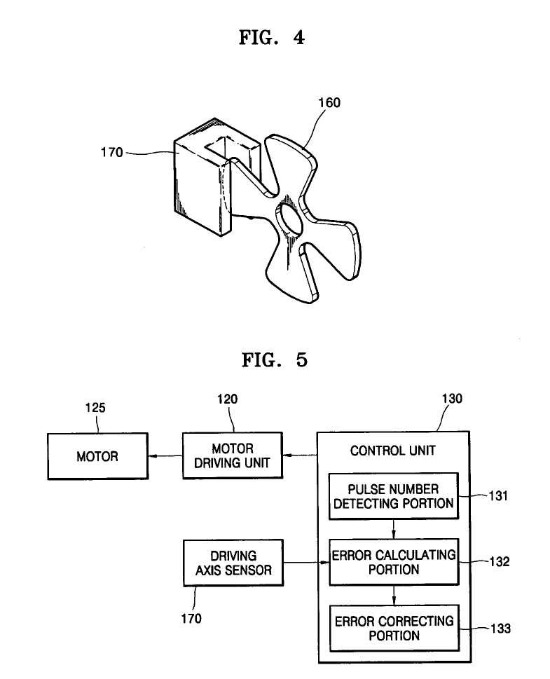

FIG. 4 illustrates in detail the impeller 160 and the driving axis sensor 170 according to an embodiment of the present invention. As shown in FIG. 4, the impeller 160 may preferably have four rotary wings 90 degrees apart from each other. The impeller 160 may also have eight rotary wings 45 degrees apart from each other. The impeller 160 may also have any other number of rotary wings in accordance with this embodiment of the present invention.

The driving axis sensor 170 includes a light emitting portion (not shown) formed on one side thereof, and a light receiving portion (not shown) formed on the other side thereof. When the light emitted from the light emitting portion passes between the rotary wings and reaches the light receiving portion, the driving axis sensor 170 outputs a high level detection signal, and when the light emitted from the light emitting portion is blocked by the rotary wings, the driving axis sensor 170 outputs a low level detection signal.

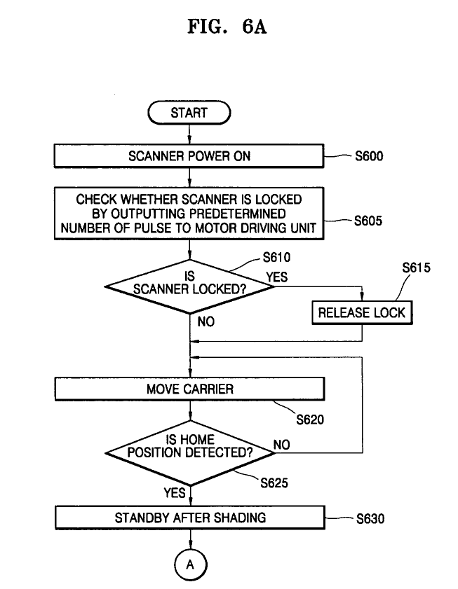

FIG. 5 is a block diagram of a carrier position detecting device of a scanner according to an embodiment of the present invention.

The carrier position detecting device includes a motor driving unit 120, a motor 125, a control unit 130, and a driving axis sensor 170. The operations of the elements included in the carrier position detecting device have been described above with reference to FIG. 3.

The control unit 130 includes: a pulse number detecting portion 131, also known as a pulse number detecting unit; an error calculating portion 132, also known as an error calculating unit; and an error correcting portion 133, also known as an error correcting unit.

The pulse number detecting portion 131 detects the number of pulses outputted to the motor driving unit 120 to drive the motor 125. A pulse generating portion (not shown) of the control unit 130 generates pulses which drive the motor 125 and outputs the pulses to the motor driving unit 120, and the pulse number detecting portion 131 detects the number of pulses outputted to the motor driving unit 120. The position of the carrier 110 is proportional to the number of pulses detected by the pulse number detecting portion 131. However, when the pulses are generated, but the motor 125 is not driven, there may be an error in the position detected by calculating the number of pulses. That is, The position of the carrier 110 is proportional to the number of pulses detected by the pulse number detecting portion 131 in case that the motor 125 is driven when the pulse generating portion (not shown) of the control unit 130 generates pulses which can drive the motor 125.

The error calculating portion 132 calculates the error by comparing the number of pulses detected by the pulse number detecting portion 131 to the number of rotations of the impeller 160. The number of rotations of the impeller 160 is characterized by a detection signal from the driving axis sensor 170. By comparing the number of pulses detected by the pulse number detecting portion 131 to the number of rotations of the impeller 160, the position error of the carrier 110 can be calculated without detecting the home position.

The error correcting portion 133 corrects the error and accurately detects a position of the carrier 110. By accurately detecting the position of the carrier 110, the quality of a scanned image can be improved.

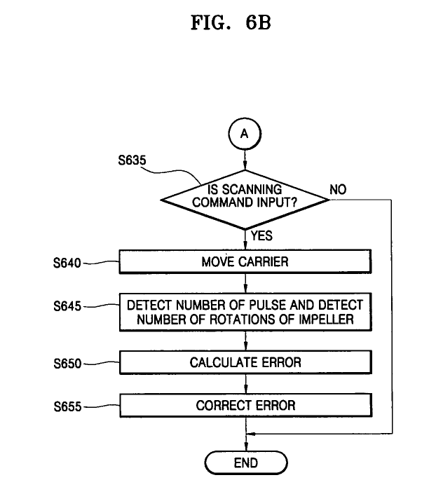

FIGS. 6A and 6B are flowcharts illustrating a method of detecting a position of a carrier according to an embodiment of the present invention. The flowcharts of FIGS. 6A and 6B will be described with reference to elements of FIGS. 3 and 5.

Referring to FIGS. 3, 5, 6A, and 6B, power is initially turned on in operation S600, and then the control unit 130 outputs a predetermined number of pulses to the motor driving unit 120 and checks whether the scanner is locked in operation S605. At this moment, the number of pulses output to the motor driving unit 120 may preferably be four or more. When the pulses are outputted to the motor driving unit 120, the driving axis sensor 170 detects whether the impeller 160 rotates and outputs a detection signal to the control unit 130. The control unit 130 checks whether the scanner is locked based on the detection signal from the driving axis sensor 170.

If the scanner is locked, the control unit 130 displays that the scanner is locked on a user interface unit (not shown) disposed on a main body of the scanner, and a scanner lock is released by the user in operation S615.

If the scanner is not locked, the motor driving unit 120 drives the motor 125 and moves the carrier 110 under the control of the control unit 130, represented as operation S620. While the carrier 110 is moved, the home position detecting sensor attempts to detect the home position in operation S620. At this moment, the control unit 130 finds out how long the carrier 120 should move based on the number of rotations of the impeller 160 detected from the driving axis sensor 170. In operation S625, the control unit 130 determines whether the home position is detected, and if the home position is not detected, the control unit 130 keeps moving the carrier 110 until the control unit 130 detects that the carrier 110 has reached the home position. If the home position is detected, in operation S630 the scanner performs a shading operation and then stands by until the next command is inputted. The shading method is well known to those of ordinary skill in the art, and thus a detailed description thereof will not be provided.

Operations S620, S625, and S630 correspond to an initializing operation of the scanner. Whilst initializing the scanner, the movement of the carrier 110 is detected based on the number of rotations of the impeller 160, and the number of rotations is detected by the driving axis sensor 170. Therefore, the carrier 110 is prevented from crashing against an end wall of the scanner.

If a scanning command is inputted in operation S635, the motor driving unit 120 drives the motor 125 under the control of the control unit 130 and moves the carrier 110 to a scanning position in operation S640. In operation S645, the pulse number detecting portion 131 detects the number of pulses outputted to the motor driving unit 120 in order to drive the motor 125, and the driving axis sensor 170 detects the number of rotations of the impeller 160. In operation S650, the error calculating portion 132 calculates an error in the position of the carrier 110 by comparing the number of pulses detected by the pulse number detecting portion 131 to the number of rotations of the impeller 160. The number of rotations of the impeller 160 is characterized by a detection signal from the driving axis sensor 170. In operation S655 the error correcting portion 133 corrects the error in the position of the carrier 110 and accurately detects the position of the carrier 110.

Even when the home position is not detected while the scanner operates in operations S635, S640, S650, and S655, a position of the carrier 110 can be accurately detected based on the number of rotations of the impeller 160 which the driving axis sensor 170 has detected, and hence, the carrier 110 can be prevented from crashing against the end wall of the scanner.

According to aspects of the present invention, since a carrier position detecting device can promptly and easily detect whether a scanner is locked by detecting the number of rotations of an impeller installed on a motor axis, noise and stress on a motor due to the scanner lock can be reduced. Moreover, even if the carrier position detecting device cannot detect a home position during scanning, a position error of the carrier that is produced during carrier movement can be accurately corrected by detecting the number of rotations of the impeller, and thus the quality of a scanned document can be improved. Also, the carrier position detecting device prevents the carrier from crashing against an end wall of the scanner if the home position cannot be found during the scanner initialization or operation.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A device which detects a position of a carrier in a scanner, the scanner comprising the carrier on which a sensor that senses an image is disposed, a motor that moves the carrier, and a motor driving unit that drives the motor, and the device comprising:
an impeller that is disposed on a driving axis of the motor and rotates as the motor is driven;
a driving axis sensor that outputs a detection signal according to the rotation of the impeller; and
a control unit that detects the position of the carrier based on the detection signal.

2. The device of claim 1, wherein the driving axis sensor comprises a light emitting unit and a light receiving unit, and outputs the detection signal according to whether light emitted from the light emitting unit is transmitted past the impeller and reaches the light receiving unit.

3. The device of claim 1, wherein, when the scanner is powered on, the control unit outputs a predetermined number of pulses to the motor driving unit and checks whether the scanner is locked based on the detection signal from the driving axis sensor.

4. The device of claim 3, wherein the predetermined number of pulses is four or more.

5. The device of claim 1, wherein the control unit comprises:
a pulse number detecting unit that detects a number of pulses outputted to the motor driving unit which drives the motor;
an error calculating unit that compares the number of pulses detected by the pulse number detecting unit with a number of rotations of the impeller which is represented by the detection signal from the driving axis sensor and calculates an error; and
an error correcting unit that corrects the error to detect the position of the carrier.

6. The device of claim 1, wherein the impeller has four rotary wings.

7. The device of claim 6, wherein the four rotary wings are spaced 90 degrees apart from each other.

8. The device of claim 1, wherein the impeller has eight rotary wings.

9. The device of claim 8, wherein the eight rotary wings are spaced 45 degrees apart from each other.

10. A method of detecting a position of a carrier in a scanner, the scanner comprising the carrier on which a sensor that senses an image is disposed, a motor that moves the carrier, and a motor driving unit that drives the motor, and the method comprising:
checking whether the scanner is locked by outputting a predetermined number of pulses to the motor driving unit when the scanner is powered on;
initializing the scanner if the scanner is not locked; and
detecting the position of the carrier by detecting a number of rotations of an impeller disposed on a driving axis of the motor when the carrier is moved in response to an input scanning command.

11. The method of claim 10, wherein the detecting the position of the carrier comprises:
detecting the predetermined number of pulses for driving the motor driving unit and detecting the number of rotations of the impeller disposed on the driving axis of the motor when the carrier is moved in response to an input scanning command;
calculating an error by comparing the predetermined number of pulses and the number of rotations of the impeller; and
correcting the error to detect the position of the carrier.

12. A device which detects whether a scanner is locked, the scanner comprising a carrier on which a sensor that senses an image is disposed, a motor that moves the carrier, and a motor driving unit that drives the motor, and the device comprising:
an impeller that is disposed on a driving axis of the motor and rotates as the motor is driven;
a driving axis sensor that outputs a detection signal according to the rotation of the impeller; and
a control unit which determines whether the scanner is locked based on the detection signal.

13. The device of claim 12, wherein the control unit also detects the position of the carrier based on a number of rotations of the impeller.

14. The device of claim 12, wherein the driving axis sensor comprises a light emitting unit and a light receiving unit, and outputs the detection signal according to whether light emitted from the light emitting unit is transmitted past the impeller and reaches the light receiving unit.

15. The device of claim 12, wherein, when the scanner is powered on, the control unit outputs a predetermined number of pulses to the motor driving unit and checks whether the scanner is locked based on the detection signal from the driving axis sensor.

16. The device of claim 15, wherein the predetermined number of pulses is four or more.

17. The device of claim 12, wherein the control unit comprises:
a pulse number detecting unit that detects a number of pulses outputted to the motor driving unit which drives the motor;
an error calculating unit that compares the number of pulses detected by the pulse number detecting unit with a number of rotations of the impeller which is represented by the detection signal from the driving axis sensor and calculates an error; and
an error correcting unit that corrects the error to detect the position of the carrier.

18. The device of claim 12, wherein the impeller has four rotary wings.

19. The device of claim 18, wherein the four rotary wings are spaced 90 degrees apart from each other.

20. The device of claim 12, wherein the impeller has eight rotary wings.

21. The device of claim 20, wherein the eight rotary wings are spaced 45 degrees apart from each other.

22. A device which reduces noise and stress on a scanner motor caused by operating the scanner motor when a scanner is locked, comprising:
an impeller that is disposed on a driving axis of the scanner motor and rotates as the scanner motor is driven;
a driving axis sensor that outputs a detection signal according to the rotation of the impeller; and
a control unit which determines whether the scanner is locked as soon as the scanner is turned on based on the detection signal received from the driving axis sensor during an initializing operation.

23. The device of claim 22, wherein the driving axis sensor comprises a light emitting unit and a light receiving unit, and outputs the detection signal according to whether light emitted from the light emitting unit is transmitted past the impeller and reaches the light receiving unit.

24. The device of claim 23, wherein, when the scanner is powered on, the control unit outputs a predetermined number of pulses to the motor driving unit and checks whether the scanner is locked based on the detection signal from the driving axis sensor.

25. The device of claim 24, wherein the predetermined number of pulses is four or more.

26. The device of claim 22, wherein the control unit comprises:
a pulse number detecting unit that detects a number of pulses outputted to the motor driving unit which drives the motor;
an error calculating unit that compares the number of pulses detected by the pulse number detecting unit with a number of rotations of the impeller which is represented by the detection signal from the driving axis sensor and calculates an error; and
an error correcting unit that corrects the error to detect the position of the carrier.

27. The device of claim 22, wherein the impeller has four rotary wings.

28. The device of claim 27, wherein the four rotary wings are spaced 90 degrees apart from each other.

29. The device of claim 22, wherein the impeller has eight rotary wings.

30. The device of claim 29, wherein the eight rotary wings are spaced 45 degrees apart from each other.
